(19) United States
(12) Patent Application Publication
(10) Pub. No.: US 2025/0171251 A1
(43) Pub. Date: May 29, 2025

(54) MANIPULATOR FOR PACKAGES AND RELATED PROCESS FOR MOVING PACKAGES

(71) Applicant: R.A JONES & CO., Covington, KY (US)

(72) Inventors: Andrea BIONDI, Bologna (IT); Luca CAVAZZA, Bologna (IT); Ivanoe BERTUZZI, Bologna (IT); Cristian DAKESSIAN, Bologna (IT)

(21) Appl. No.: 18/724,947

(22) PCT Filed: Dec. 23, 2022
(86) PCT No.: PCT/IB2022/062714

§ 371 Date: Jun. 27, 2024

(30) Foreign Application Priority Data
Dec. 29, 2021 (IT) 102021000032936

(51) Int. Cl. B65G 47/91; B25J 9/00; B25J 9/04; B25J 15/00; B25J 15/02; B25J 15/06; B65B 5/04; B65G 47/92

(52) U.S. Cl. CPC B65G 47/914; B25J 9/0093; B25J 9/04; B25J 15/0052; B25J 15/0206; B25J 15/0616; B65B 5/04; B25J 15/06; B65G 47/92

(57) ABSTRACT

A manipulator for packages with variable geometry includes a pair of gripping elements movable from an open configuration to a gripping configuration and vice versa, and cooperating with each other to grasp one of said packages. The manipulator further includes a plurality of adhesion elements interposed between the gripping elements, wherein each of said adhesion elements is mounted on a respective elastic support capable of varying their extension independently of each other.

The present invention relates to a process for moving packages with variable geometry. It is also directed to a manipulator for packages with variable geometry and to the relative apparatus.

The content of the Italian patent application No. 102021000032927, filed on 29 Dec. 2021 by the same Applicant, entitled “Process for moving packages and manipulator for packages provided to operate according to this process” is considered fully incorporated herein.

The present invention finds a preferred, although not exclusive, application in the field of packages of food and non-food products, an example of which is represented by cereal bags, for example oat flakes or puffed rice, packages to which reference may be made later without losing generality.

In particular, in this technical field processes for moving packages are known, mainly based on the use of conveyor belts, in which the boxing step is carried out by means of an element that pushes the package with variable geometry, for example a cereal bag, inside a preformed rigid box.

Typically, in the plants for the boxing cereal bags, these are moved on linear conveyor belts and, sometimes, pass from one belt to another by gravity. In addition, the step of inserting the bag into the rigid package, usually of cardboard, takes place by aligning a box with a bag, along the longitudinal extension of the box and by pushing, with a spatula-like element, the bag into the box.

Alternatively, some plants envisage boxing the package with variable geometry by depositing the latter in a mandrel and by wrapping around the mandrel itself a cardboard blank so as to form a box (so-called “wrap-around” process).

In this description as well as in the accompanying claims, certain terms and expressions are deemed to have, unless otherwise expressly indicated, the meaning expressed in the following definitions.

A package is said to be with “variable geometry” when, due to the nature of the product contained in it, the package does not have a defined shape. In particular, the package may be a bag or a pouch containing bulk material, for example granular or flake or powder material, or material in liquid form.

“Adhesion element” referred to a manipulator means a retaining element capable of retaining an object by contact, specifically they can be suction cups or magnets, velcro and/or surfaces coated with temporary glues.

“Vertical” or “vertically” means a direction parallel to the direction defined by the force of gravity or which deviates from the direction defined by the force of gravity by a maximum of 10°; by the term to lower it is meant a vertical displacement with a direction concordant with gravity, by the term to lift it is meant a vertical displacement with a direction discordant with gravity.

“Horizontal” or “horizontally” means a direction belonging to a plane perpendicular to the direction of the force of gravity.

“Gripping configuration” means a closed configuration of the gripping elements, wherein said gripping elements are approached to each other so as to be able to grasp a package.

“Open configuration” means a configuration in which the gripping elements are spaced apart from each other with respect to the gripping configuration, such that they are not able to grasp a package.

The Applicant has preliminarily observed that the passage from one conveyor belt to another by gravity frequently causes the crushing of part of the contents of the package with variable geometry, which often consists of relatively fragile products.

Furthermore, the Applicant has observed that this drawback is further aggravated when high capacities of the production apparatus are required, where the packages are moved at high speeds subjecting them to relatively violent shocks that worsen the quality of the end product.

In particular, the Applicant has observed that the passage between linear conveyor belts can take place by moving said package with variable geometry with manipulators comprising grippers that advantageously pick up the bag from a first conveyor belt and place it on a second conveyor belt. In this way, there is no impact due to the fall at high speed between one belt and the other and therefore the possibility of breaking the loose materials contained in said packages with variable geometry is limited.

However, the Applicant has observed that in the “wrap-around” type boxing processes in which the package is envisaged to be deposited inside a mandrel, the use of the grippers is generally not sufficient to prevent the package from falling. In fact, due to the shape of the mandrel, the gripper is not normally able to deposit the package on the bottom of the mandrel, and then open and exit the mandrel, so that, typically, the package must be released from the gripper above the mandrel in order to fall inside it.

The Applicant has also verified that in the processes at high production capacity the use of transfer devices of the rotating type is preferred, which can operate continuously advantageously avoiding the mechanical complications and the slowdowns due to the acceleration and deceleration steps of discontinuous type transfer devices.

For example, the Applicant has verified how a transfer device comprising a wheel or a drum, or more generally a belt wound on a closed path, and on which a plurality of manipulators are mounted with relative movement capability that grasp an article from a starting point and retain it during the rotation of the wheel or of the drum or of the belt until releasing it at an arrival point, is particularly effective and reliable in terms of production capacity and precision in the transfer.

The Applicant, however, has found that the particular required movement requires to accessorize said manipulators with adhesion elements, which retain the package with variable geometry during the rotation of the transfer device, counteracting the centrifugal force generated.

Said adhesion elements, in fact, have the purpose of ensuring a better grip of the package with variable geometry by the manipulator. In fact, given the indefinite nature of the shape of the packages, a possible variation in the distribution of the product in its inside could cause the package to come off the gripper.

The Applicant has also verified that if the manipulator comprised only the adhesion elements, given the nature of the products contained in the packages with variable geometry, the dust present inside the plant might not ensure the complete sealing of the adhesion elements over time, causing the possible fall of the package with variable geometry. However, the Applicant has found that, due to their indefinite shape, the packages with variable geometry are poorly able to be retained by means of adhesion elements that require, by their functional characteristics, to come into contact completely with the surface of the package.

In particular, the Applicant has perceived that the issue laid in the fact that the adhesion elements were not able to adapt to the inhomogeneities of the packages with variable geometry and has therefore realised that by mounting the adhesion elements on elastic supports that vary their extension independently of each other, the adhesion elements would have been able to adapt also to the variations in the geometry of the package, improving the effectiveness of the retaining action.

Finally, the Applicant has found that a manipulator on which a pair of gripping elements in open configuration and a plurality of adhesion elements interposed between the gripping elements are mounted, wherein each adhesion element is mounted on a respective elastic support able to adapt its extension independently of the other adhesion elements, allows to move the packages with variable geometry between a starting point and an arrival point in a safe and effective way, minimizing the risk of falling or impacts that lead to a crushing of the product contained in the package.

Thus, in a first aspect thereof, the present invention is directed to a manipulator for packages with variable geometry.

Preferably, said manipulator comprises a pair of gripping elements.

Preferably, said gripping elements are movable from an open configuration to a gripping configuration and vice versa.

Preferably, said gripping elements are cooperating with each other to grasp one of said packages.

Preferably, said manipulator comprises a plurality of adhesion elements.

Preferably, the adhesion elements are interposed between the gripping elements.

Preferably, each of said adhesion elements is mounted on a respective elastic support.

Preferably, each respective elastic support is capable of varying its extension independently of the other elastic supports.

In a second aspect thereof, the present invention is directed to a process for moving packages with variable geometry.

Preferably, said process comprises the step of providing a manipulator on which a pair of gripping elements is mounted in an open configuration.

Preferably, said process comprises the step of providing a plurality of adhesion elements.

Preferably, said adhesion elements are interposed between the gripping elements.

Preferably, each of said adhesion elements is mounted on a respective elastic support.

Preferably, said process comprises the step of making said plurality of adhesion elements adhere to said package by adjusting the extension of said respective elastic supports to adapt said adhesion elements to the geometry of said package.

Preferably, said process comprises the step of bringing the gripping elements into a gripping configuration to grasp said package.

Preferably, said process comprises the step of moving said package by means of said manipulator between two points.

Preferably, said process comprises the step of releasing said package.

Thanks to these characteristics, the process for moving packages with variable geometry and the manipulator for packages with variable geometry allow to precisely move a package with variable geometry, preferably containing a loose product, between a starting point and an arrival point, minimizing the damages to the contained product and minimizing rejected or lost packages during the movement step. Advantageously, with said movement process it is also possible to move said packages in packaging plants that provide for a movement on curvilinear trajectories even at high speed.

In a third aspect thereof, the present invention is directed to an apparatus for boxing packages with variable geometry comprising a manipulator according to the first aspect.

Preferably, in said apparatus, said manipulator is mounted on a carousel.

In at least one of the aforementioned aspects, the present solution may further have at least one of the preferred features set forth below.

Preferably, said elastic supports are springs.

The springs vary their extension independently of each other and in this way, the adhesion of the adhesion elements is ensured, minimizing the possibility of losing the package in the movement step between two points.

In other embodiments the elastic supports may be bodies made of elastomeric material.

Preferably, said adhesion elements with respective elastic supports are mounted on a plate.

Preferably, the position of said plate is adjustable with respect to the gripping elements, more preferably, said plate is vertically movable with respect to said gripping elements.

Preferably, said adhesion elements with the respective elastic supports are arranged on said plate in an orderly manner.

Preferably, said adhesion elements are two and are arranged along a centreline of said plate.

Preferably, the position of each of said adhesion elements on said manipulator, more preferably on said plate, is mutually adjustable.

In one embodiment, the position of at least one, and preferably each, of said adhesion elements on said manipulator is variable with respect to the other adhesion elements along a plane substantially perpendicular to a direction defined by said extension of said elastic supports.

In one embodiment, said plane is substantially horizontal.

Preferably, said plane is defined by said plate.

Preferably, said plate comprises movement paths, along which it is possible to move said adhesion elements, varying their position on said plate.

Preferably, the movement of said adhesion elements takes place manually, alternatively it takes place through movement actuators included in said manipulator.

Advantageously, moving the adhesion elements so as to modify their mutual position allows the manipulator to adapt to grasping bags with very different dimensions, simply by appropriately distributing the adhesion elements on the plate.

In some embodiments, the adhesion elements are one among suction cups, magnetic elements, velcro, or a combination thereof.

Preferably, said adhesion elements are suction cups.

Preferably, said suction cups are connected to a suction circuit.

Preferably, said suction circuit of the suction cups comprises a pump and a control unit.

Alternatively, said suction circuit of the suction cups comprises a venturi effect generator and a control unit.

Preferably said control unit is a solenoid valve.

In this way suction cups can be easily activated and deactivated, controlling the suction flow.

Preferably, said gripping elements comprise a plurality of prongs.

Preferably, said prongs have an end portion turned towards the other gripping element.

In some embodiments, the distance between said gripping elements when in said open configuration or in said gripping configuration, is adjustable.

In one embodiment, said distance between said gripping elements is adjustable by manually displacing at least one of said gripping elements away from or towards the other of said gripping elements.

Preferably, said manipulator comprises spacing actuators that vary said distance between said gripping elements.

Advantageously, it is thus possible to modify the useful gripping volume of said manipulator, by this term meaning the volume delimited by said gripping elements and by said adhesion elements, allowing the manipulator to adapt to packages with dimensions that are very different from one another.

In some embodiments, said plurality of adhesion elements is made to adhere to said package by approaching said manipulator to said package.

Preferably, said plurality of adhesion elements is made to adhere to said package by approaching said manipulator to said package, more preferably by lowering said manipulator to said package.

In some embodiments, while said manipulator is lowered onto said package, said gripping elements are closed.

In this way, the substantial contemporaneity of the two actions allows to maintain high production speeds, minimizing the movement times.

In some embodiments, said package is moved substantially within a geometric plane.

In this way it is the manipulator that changes its position depending on the geometric plane on which said package with variable geometry must move.

Preferably, said geometric plane is a horizontal geometric plane.

In some embodiments, said package is released by separating it from the adhesion elements and returning the gripping elements to said open configuration.

Preferably, the separation of the adhesion elements from said package and the displacement of the gripping elements in open configuration take place simultaneously.

Preferably, said suction cups are made to adhere to said package, depressurising them through a suction circuit.

In some embodiments, said manipulator is moved along a curvilinear trajectory.

Preferably, the package with variable geometry is a pouch containing bulk material.

In some embodiments, at least one point between which said package is moved is a conveyor belt comprising containment elements for containing said package. Preferably, said gripping elements are shaped to couple with said containment elements of said conveyor belt.

Preferably, said prongs are arranged so as not to collide with said containment elements when said manipulator is near said conveyor belt.

In this way, the manipulator can grasp or release the package near the surface of the conveyor belt for positioning and/or transporting said package, without interfering with the containment elements (also known by the term “carriers”) of the conveyor belt.

Preferably, said manipulator is connected to said carousel through an electromechanical arm.

Preferably, said suction circuit is mounted on said arm.

Preferably, said manipulator also comprises a main body to which a rotational actuator comprised in each gripping element is rotatably connected.

According to some preferred embodiments of the invention, said rotational actuators, in addition to being free to rotate each one around its own axis of rotation, can be displaced horizontally as a function of the transversal dimension of the package with variable geometry to be grasped.

It should be noted that some steps of the process described above may be independent of the order of execution reported, unless a sequentiality or simultaneity between two or more steps is expressly indicated as necessary. In addition, some steps may be optional. In addition, some steps of the process may be performed repetitively, or they may be performed in series or in parallel with other steps of the method.

The characteristics and advantages of the invention will become clearer from the detailed description of a preferred embodiment thereof, by way of non-limiting example, with reference to the appended drawings wherein:

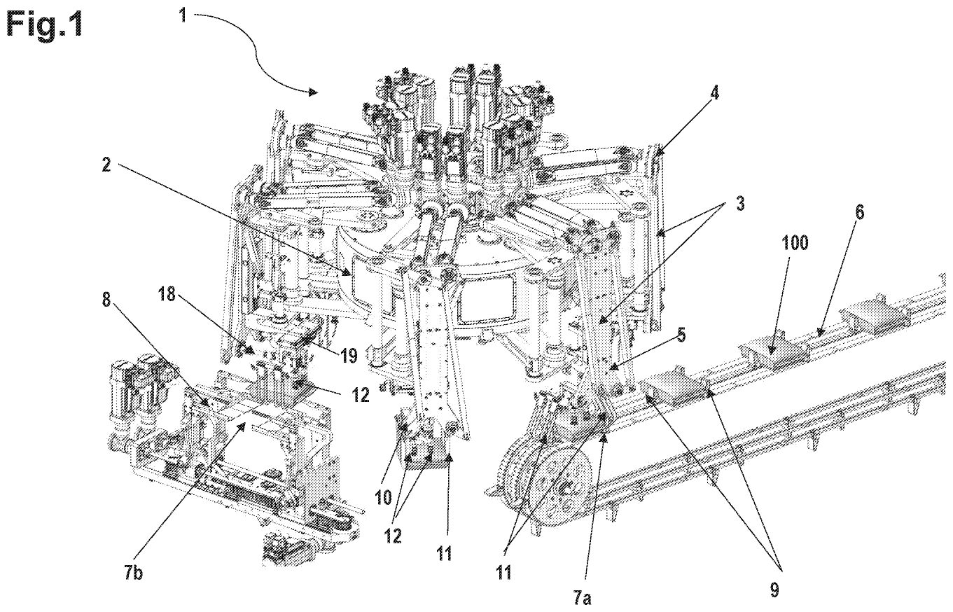

FIG. 1 is a perspective view of an apparatus for boxing packages with variable geometry provided with manipulators made in accordance with this solution;

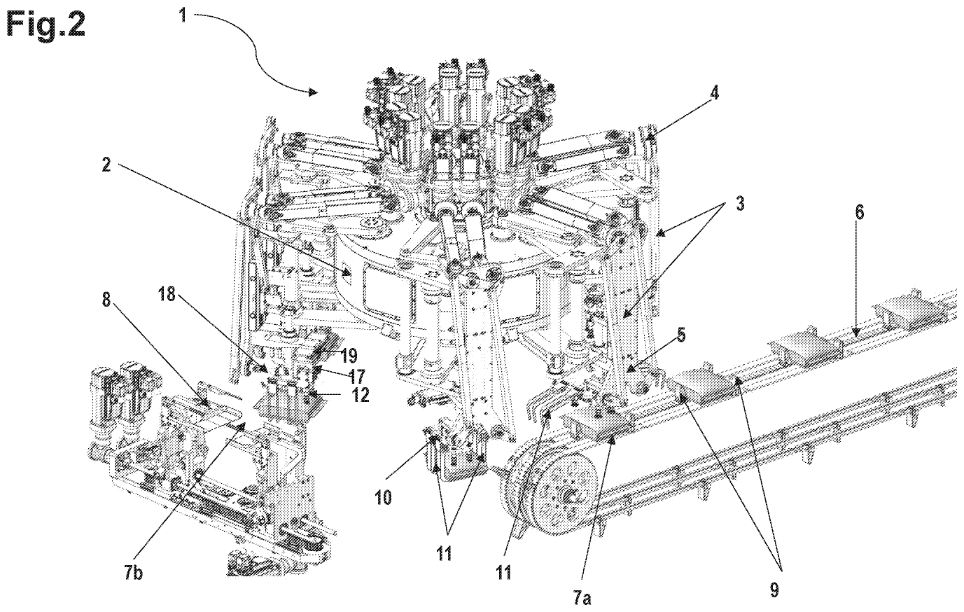

FIG. 2 is another perspective view of the apparatus of FIG. 1;

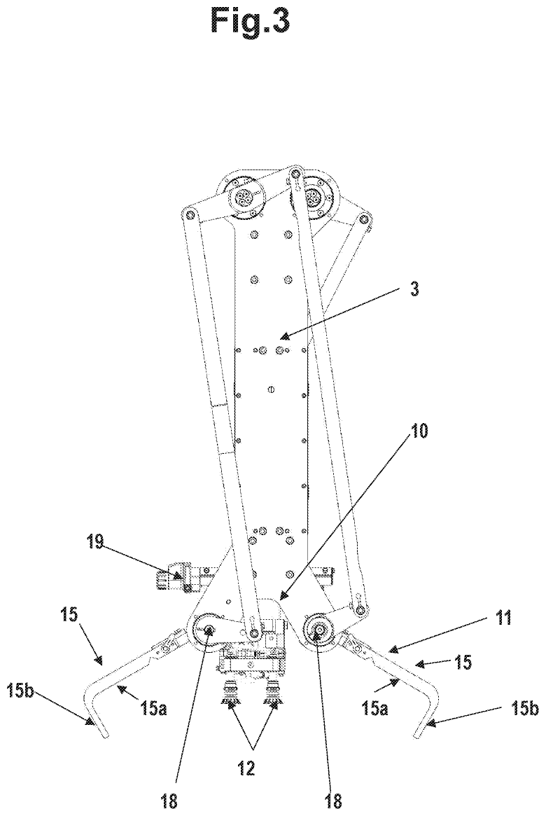

FIG. 3 is a front view of a manipulator of FIG. 1 with the gripping elements in open configuration;

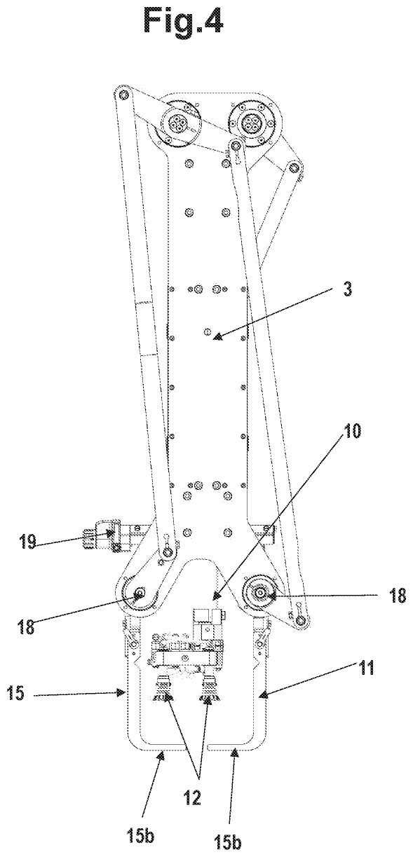

FIG. 4 is a front view of the manipulator of FIG. 3 with the gripping elements in gripping configuration;

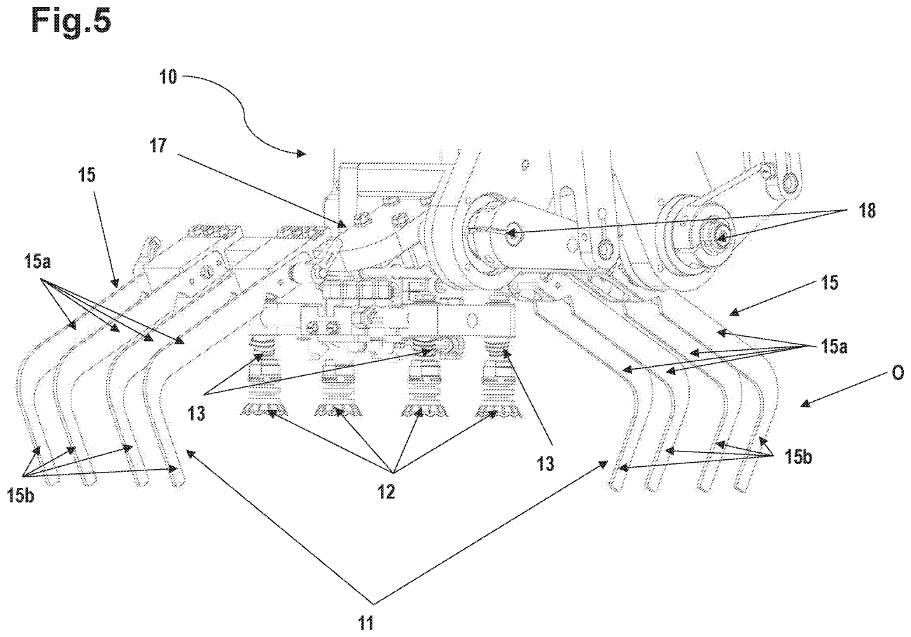

FIG. 5 is an enlarged scale perspective view of the manipulator of FIG. 3 with the gripping elements in open configuration;

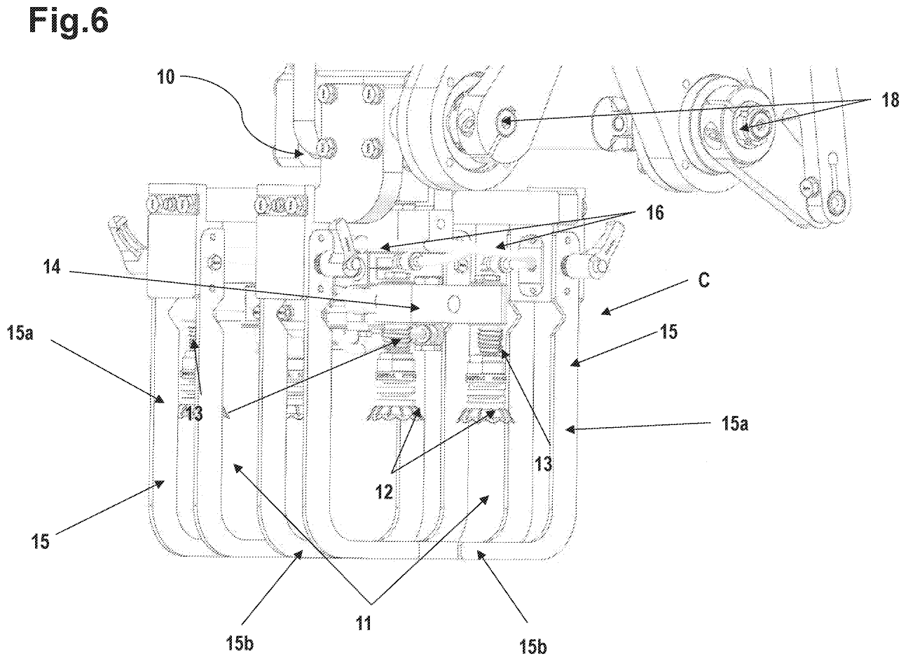

FIG. 6 is a perspective view of the manipulator of FIG. 5 with the gripping elements in gripping configuration;

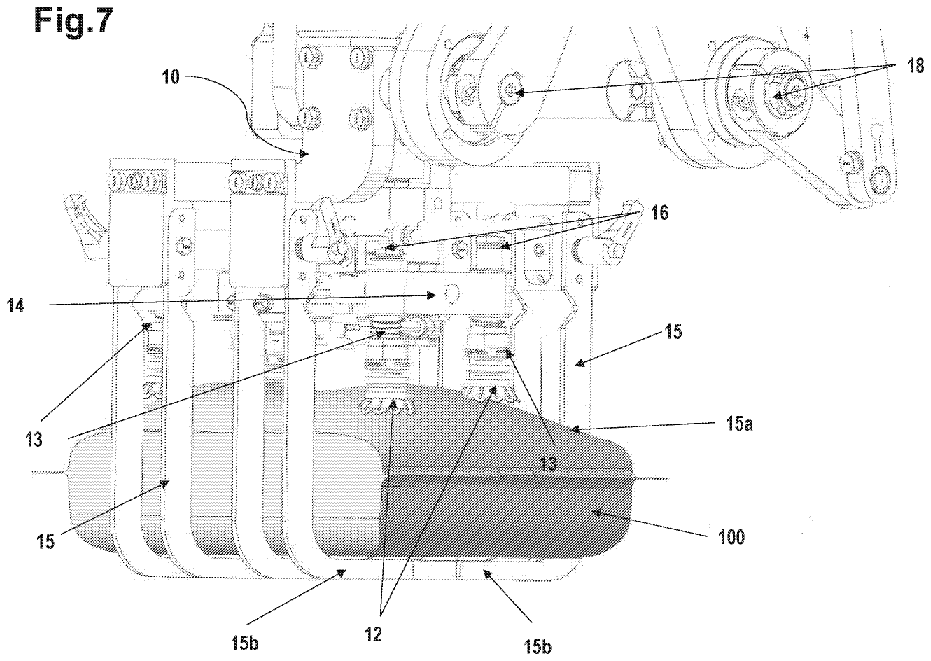

FIG. 7 is a perspective view of the manipulator of FIG. 6 with the gripping elements in gripping configuration around a package with variable geometry.

With reference to the accompanying figures, an apparatus for boxing packages 100 with variable geometry is indicated as a whole with 1, for simplicity also called only packages 100, in accordance with this solution. In the preferred case described herein the packages 100 with variable geometry are bags containing cereals that must be moved between a starting point 7a and an arrival point 7b.

For this purpose, the apparatus 1 comprises a carousel 2 on which a plurality of manipulators 10 are mounted through respective electromechanical arms 3.

Each arm 3 comprises a first end 4 connected to said carousel 2 and a second end 5 connected to said manipulator 10.

Said electromechanical arms 3 have three degrees of freedom that allow the vertical, horizontal and rotational displacement of each manipulator 10. Each arm 3 during each turn of carousel 2 can assume several positions: a radial position with respect to the axis of rotation of said carousel 2, or that deviates from the radial one by an angle comprised between −60° and +60°. Said variation of position allows said arm 3 to vary its rotational speed for each turn of carousel 2.

In the preferred case described herein, the apparatus 1 comprises at least one conveyor belt 6 of the packages 100 with variable geometry, which arrives near the carousel 2 and from which the manipulator 10 picks up said packages 100 at a point of the conveyor belt 6 that defines the starting point 7a of the movement of the packages 100 by means of the manipulator 10.

Said conveyor belt 6 in turn comprises containment elements 9, also called carriers, among which packages 100 with variable geometry are released.

In the preferred case described herein, said apparatus 1 also comprises a mandrel 8 in which the manipulator 10 deposits the package 100 with variable geometry. The mandrel 8 thus defines the arrival point 7b of the movement of the packages 100 by means of the manipulator 10.

Said mandrel 8 moves along a curvilinear trajectory.

Advantageously, the rotational speed variation allows the arm 3 to stay longer on the starting point 7a and on the arrival point 7b so as to pick up and release the package 100 with variable geometry minimizing the impacts and damages to the product contained in the packages 100.

Said rotational speed variation allows the manipulator 10 also to couple with said containment elements 9 during the picking of the package 100 with variable geometry.

Each manipulator 10 comprises a pair of gripping elements 11, movable from an open configuration O to a gripping configuration C and vice versa, and cooperating with each other to grasp one of said packages 100.

The manipulator 10 further comprises a plurality of adhesion elements 12, interposed between the gripping elements 11.

Each adhesion element 12 is mounted on a respective elastic support 13 capable of adapting its extension, in particular along a substantially vertical direction, independently of the other elastic supports 13.

In the preferred case described herein, the adhesion elements 12 are suction cups connected to a suction circuit 16 while the elastic supports 13 are springs.

The suction cups and the respective springs are mounted on a plate 14 with adjustable position with respect to said gripping elements 11. The plate 14 has a rectangular shape and the suction cups and the respective springs are four and are arranged symmetrically on said plate 14, in particular they are equally spaced from the axes of symmetry of said plate 14.

The plate 14 comprises movement paths, along which it is possible to move the suction cups, varying their position on a substantially horizontal plane, perpendicular to the direction of extension of the elastic supports 13.

The movement of said suction cups can take place manually, alternatively it can take place through movement actuators comprised in said manipulator 10.

The gripping elements 11 of the manipulator 10 comprise a plurality of prongs 15, in the preferred case described herein each comprising four equally spaced prongs 15.

The distance between the prongs 15 of each gripping element 11 is between 2 cm and 5 cm depending on the dimensions of the package with variable geometry 100 to be grasped.

The prongs 15 of each gripping element 11 have a first portion 15a and an end portion 15b turned towards the other gripping element 11.

The first portion 15a of each of said prongs 15 is connected to a respective rotational actuator 18 which moves the prongs 15 from the open configuration O, substantially like gull wings, to the gripping configuration C, in which the end portions 15b are close to each other, spaced 1 cm-3 cm apart.

The manipulator 10 also comprises a main body 17 to which the rotational actuators 18 of the gripping elements 11 are rotatably connected.

Said main body 17 represents the connection element between the electromechanical arm 3 and the manipulator 10.

The manipulator 10 comprises spacing actuators that vary the horizontal distance between the gripping elements 11, modifying the useful gripping volume of the manipulator 10 itself. This feature allows the manipulator 10 to adapt to bags with dimensions that are very different from one another.

The plate 14 to which the suction cups are connected with the respective springs is slidably connected to the main body 17 with respect to which it is free to slide vertically.

The vertical sliding of the plate 14 takes place by means of a vertical actuator 19 mounted on the electromechanical arm 3.

The suction circuit 16 of the suction cups comprises a pump and a control unit 20 that are installed on said arm 3.

To move the cereal bags, the manipulator 10 is arranged in an open configuration O, in which the prongs 15 are open and the springs are at rest. Once the manipulator 10 is arranged in such an open configuration O, it is lowered on said bag to make said plurality of adhesion elements 12 adhere thereto, adapting the extension of the springs of each adhesion element 12 to the variable geometry of the package 100, while the gripping elements 11 are closed.

At the same time, the suction circuit 16 to which the suction cups are connected is activated.

When activated, the suction circuit 16 depressurises the suction cups while they are adhering to the cereal bag.

Concurrently with the adhesion of the suction cups, the prongs 15 are closed, so that the manipulator 10 can grasp the bag and displace it from the starting point 7a to the arrival point 7b.

Once the arrival point 7b is reached, the manipulator 10 releases the package 100 with variable geometry that is placed on the arrival point 7b, and while the gripping elements 11 pass into the open configuration O, the suction in the suction circuit 16 is blocked and the suction cups are lifted thanks to the movement of the plate 14 that is displaced vertically moving away from the package 100 with variable geometry.

1.-20. (canceled)

21. A manipulator for packages with variable geometry, said manipulator comprising:
a pair of gripping elements movable from an open configuration to a gripping configuration and vice versa, and configured to cooperate with each other to grasp one of said packages, and
a plurality of adhesion elements interposed between the pair of gripping elements, each adhesion element of said plurality of adhesion elements mounted on a respective elastic support of elastic supports, the respective elastic support capable of varying an extension of the respective elastic support independently of other elastic supports.

22. The manipulator according to claim 21, wherein said elastic supports are springs.

23. The manipulator according to claim 21, wherein said plurality of adhesion elements mounted on elastic supports are mounted on a plate.

24. The manipulator according to claim 23, wherein a position of said plate is adjustable with respect to the pair of gripping elements.

25. The manipulator according to claim 21, wherein said plurality of adhesion elements comprise at least one of: suction cups and magnetic elements.

26. The manipulator according to claim 21, wherein each of the pair of gripping elements comprises a plurality of prongs.

27. The manipulator according to claim 26, wherein each prong of said plurality of prongs of a first gripping element has an end portion pointing towards a second gripping element.

28. The manipulator according to claim 21, wherein the position of each adhesion element of said plurality of adhesion elements on said manipulator is adjustable.

29. A process for moving packages with variable geometry, the process comprising:
providing a manipulator on which a pair of gripping elements is mounted in an open configuration;
providing a plurality of adhesion elements interposed between the pair of gripping elements, each adhesion element of said plurality of adhesion elements being mounted on a respective elastic support of a plurality of elastic supports;
adhering said plurality of adhesion elements to said package by adjusting an extension of each of said plurality of elastic supports to adapt said plurality of adhesion elements to the geometry of said package;
bringing the pair of gripping elements into a gripping configuration to grasp said package;
moving said package by said manipulator from a first point to a second point; and
releasing said package.

30. The process according to claim 29, wherein the adhering said plurality of adhesion elements to said package comprises approaching said manipulator to said package.

31. The process according to claim 30, wherein the adhering said plurality of adhesion elements to said package further comprises lowering said manipulator onto said package adhering said plurality of adhesion elements to said package while the pair of gripping elements are closing.

32. The process according to claim 29, wherein the moving said package comprises moving said package within a geometric plane.

33. The process according to claim 32, wherein said geometric plane is a horizontal geometric plane.

34. The process according to claim 29, wherein the releasing said package comprises separating the package from the adhesion elements and returning the gripping elements to said open configuration.

35. The process according to claim 29, wherein said plurality of adhesion elements comprise at least one suction cup made to adhere to said package by depressurising said at least one suction cup through a suction circuit.

36. The process according to claim 29, wherein the moving said package by said manipulator is along a curvilinear trajectory.

37. The process according to claim 29, wherein a package of said packages with variable geometry is a bag containing loose material.

38. The process according to claim 29, wherein at least the first point or the second point is a point of a conveyor belt, the conveyor belt comprising containment elements for containing said packages.

39. The process according to claim 38, wherein said pair of gripping elements are shaped to couple with said containment elements of said conveyor belt.

40. An apparatus for boxing packages with variable geometry, the apparatus comprising a manipulator according to claim 21 wherein said manipulator is mounted on a carousel.
